(19) United States
(12) Patent Application Publication
(10) Pub. No.: US 2025/0386109 A1
(43) Pub. Date: Dec. 18, 2025

(54) IMBALANCE REDUCTION FOR A COLOR FILTER ARRAY (CFA)

(71) Applicant: QUALCOMM Incorporated, San Diego, CA (US)

(72) Inventors: Jing Wang, Saratoga, CA (US); Jinsu Kim, Seongnam-si (KR); Xiaoyun Jiang, San Diego, CA (US)

(21) Appl. No.: 18/743,296

(22) Filed: Jun. 14, 2024

(51) Int. Cl. H04N 25/11; H04N 23/88

(52) U.S. Cl. CPC H04N 25/11; H04N 23/88

(57) ABSTRACT

An apparatus includes a processing system comprising one or more memories and one or more processors coupled to the one or more memories. The processing system is configured to receive first image data from a camera that is associated with a color filter array (CFA) having multiple channels and to output second image data based on the first image data and further based on a plurality of gain values based on the first image data. The plurality of gain values include a first gain value associated with a first subset of pixels of the first image data and further include a second gain value associated with a second subset of pixels of the first image data. The second gain value is based at least in part on the first gain value.

### TECHNICAL FIELD

Aspects of the present disclosure relate generally to image processing, and more particularly, to imbalance reduction associated with a color filter array (CFA) in image processing.

### DESCRIPTION OF THE RELATED TECHNOLOGY

Image capture devices may be used to capture digital images, such as still images for photos or sequences of images for videos. Image capture devices may be incorporated into a variety of devices. For example, image capture devices may be implemented as stand-alone digital cameras, digital video camcorders, camera-equipped wireless communication device handsets (such as cellular telephones or satellite telephones), personal digital assistants (PDAs), tablets, gaming devices, computing devices, webcams, video surveillance cameras, wearable devices, or other devices with digital imaging or video capabilities.

These image capture devices may use image sensors to detect intensity of light via an array of pixels and to output signals indicating the light intensity for each pixel. Examples of such image sensors may include a charge-coupled device (CCD) sensor and an active-pixel sensor (APS). Further, an image sensor may use a color filter array (CFA) to detect colors of the light and to output signals indicating the light colors.

One example of a CFA is a Bayer CFA. The Bayer CFA may include multiple channels for sensing different colors, such as green channels, red channels, and blue channels. Further, because the human eye is typically more sensitive to green than to other colors, Bay CFAs may include twice as many green channels than red channels and blue channels. In some devices, the greater quantity of green channels may result in a channel imbalance in which two or more green pixels may have different responses to the same image content, which may generate artifacts in a rendered image. An example of a channel imbalance is a green imbalance in a Bayer CFA. Channel imbalance correction may be used to reduce or correct such imbalances, particularly in image sensors with smaller pixel size and higher spatial resolution.

Some devices may use calibration techniques to attempt to correct a channel mismatch. Calibration may be infeasible in some designs. For example, calibration may use large calibration data tables for higher-resolution image sensors or for a wide range of optical image stabilization (OIS) positions. Storage and retrieval of such large calibration data tables may utilize a large amount of processing resources and memory resources. Further, performing calibration on each image capture device individually during manufacturing may increase cost, complexity, and duration of a manufacturing process.

### SUMMARY

The systems, methods and devices of this disclosure each have several innovative aspects, no single one of which is solely responsible for the desirable attributes disclosed herein.

In some aspects, an apparatus includes a processing system comprising one or more memories and one or more processors coupled to the one or more memories. The processing system is configured to receive first image data from a camera that is associated with a color filter array (CFA) having multiple channels and to output second image data based on the first image data and further based on a plurality of gain values based on the first image data. The plurality of gain values include a first gain value associated with a first subset of pixels of the first image data and further include a second gain value associated with a second subset of pixels of the first image data. The second gain value is based at least in part on the first gain value.

In some other aspects, a method includes receiving first image data from a camera that is associated with a color filter array (CFA) having multiple channels and outputting second image data based on the first image data and further based on a plurality of gain values based on the first image data. The plurality of gain values include a first gain value associated with a first subset of pixels of the first image data and further include a second gain value associated with a second subset of pixels of the first image data, and the second gain value is based at least in part on the first gain value.

In some additional aspects, a non-transitory computer-readable medium stores instructions executable by one or more processors to initiate, perform, or control operations. The operations include receiving first image data from a camera that is associated with a color filter array (CFA) having multiple channels and outputting second image data based on the first image data and further based on a plurality of gain values based on the first image data. The plurality of gain values include a first gain value associated with a first subset of pixels of the first image data and further include a second gain value associated with a second subset of pixels of the first image data, and the second gain value is based at least in part on the first gain value.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a block diagram illustrating an example device for performing image capture from one or more image sensors.

FIG. 2 is a block diagram illustrating an example data flow path for image data processing in an image capture device.

FIG. 3 is a block diagram illustrating an example of a dynamic imbalance reduction engine.

FIG. 4 is a block diagram illustrating an example of performing a raster scan using a color filter array (CFA).

FIG. 5 is a flow chart illustrating an example method for image processing. Like reference numbers and designations in the various drawings indicate like elements.

### DETAILED DESCRIPTION

An image capture device may dynamically determine gain values on-the-fly (OTF) to reduce or a correct channel imbalance per color associated with a color filter array (CFA). For example, after capture of the image, an image signal processor (ISP) may perform a raster scan of the image based on the CFA. The raster scan may include selecting pixels of the image data corresponding to blue channels of the CFA. The ISP may determine, for each position of the CFA relative to the image data during the raster scan, a gain value associated with the pixels. The ISP may perform channel imbalance reduction by applying the gain values to the pixels associated with the blue channels of the CFA (e.g., independently of, and without applying the gain values to, pixels associated with the red channels of the CFA and pixels associated with the green channels of the CFA). Further, the ISP may apply another set of gain values to the pixels associated with the red channels of the CFA (e.g., independently of, and without applying such gain values to, pixels associated with the blue channels of the CFA and pixels associated with the green channels of the CFA). The ISP may also apply an additional set of gain values to the pixels associated with the green channels of the CFA (e.g., independently of, and without applying such gain values to, pixels associated with the blue channels of the CFA and pixels associated with the red channels of the CFA). Accordingly, the ISP may determine and may apply gain values on a per-color basis.

In some implementations, each gain value may be determined based on prior gain values determined in connection with the raster scan (e.g., using a moving weighted average of the gain values). Further, in some implementations, the ISP may identify one or more relatively homogenous (or “flat”) regions of the image data where pixels associated with different channels of the CFA have approximately equal intensities. A gain value for such a relatively homogenous region may be weighted more heavily in the moving average than a gain value associated with a non-homogenous region of the image data.

By dynamically determining gain values to reduce or correct a channel imbalance, performance may be improved and cost and complexity may be reduced as compared to other techniques. For example, a device may avoid the storage and retrieval of a large calibration data table, which may use a relatively valuable non-volatile memory for storage, such as by using one-time programmable (OTP) memory. As a result, availability of processing resources and memory resources may be increased.

As another example, individual calibration of devices to reduce channel imbalance during manufacturing may be avoided. Individually operating each device to calibrate for channel imbalance consumes time and equipment and incurs cost. Accordingly, dynamic determination of gain values may reduce cost, complexity, and duration of a manufacturing process.

In addition, dynamic determination of gain values may be more resilient to certain variations (e.g., manufacturing variations or variations that occur during device operation) as compared to some calibration processes. For example, variations may occur during device operation, such as due to changes in color temperature, lens position, or optical image stabilization (OIS) position. A calibration technique that uses a static calibration data table may be unable to account for such variations.

Further, dynamic determination of gain values may scale more favorably for some types of designs. Such designs may include higher resolution image sensors, OIS techniques that use a large range of OIS positions, and other designs. In some cases, a calibration process may be infeasible to implement with such designs (e.g., where a calibration process cannot be performed for a large range of OIS positions).

Additionally, dynamic determination of gain values may improve performance as compared to a calibration process in some cases. For example, some calibration processes may attempt to reduce the size of a calibration data table by applying a “one size fits all” calibration profile for different operating conditions. Such a technique may result in poor image quality (e.g., where a channel mismatch is conspicuous in an output image for at least some of the operating conditions). Other calibration processes may attempt to use interpolation to create multiple different calibration profiles for different operating conditions. Such a technique may decrease performance by, for example, increasing latency and by consuming processing resources and memory resources.

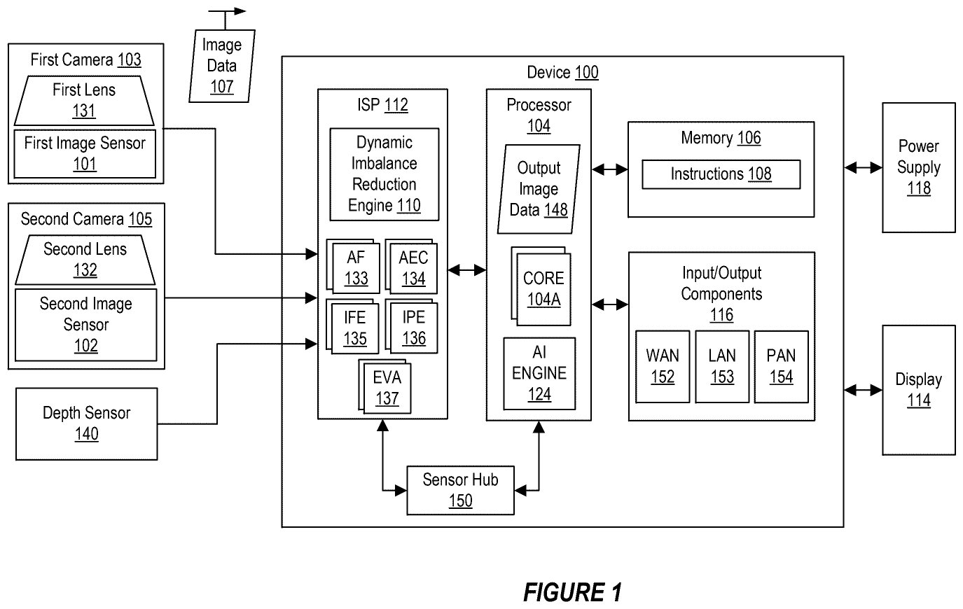

FIG. 1 shows a block diagram of a device 100 for performing image capture from one or more image sensors. The device 100 may include, or be coupled to, an image signal processor (ISP) 112 for processing image data from one or more image sensors, such as a first image sensor 101, a second image sensor 102, and a depth sensor 140. In some implementations, the device 100 also includes or is coupled to a processor 104 and a memory 106 storing instructions 108 (e.g., a memory storing processor-readable code or a non-transitory computer-readable medium storing instructions). The device 100 may also include or be coupled to a display 114 and components 116. Components 116 may be used for interacting with a user. For example components 116 may include a touch screen interface and/or physical buttons.

Components 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 WiFi wireless network adapter. A PAN adaptor 154 may be a Bluetooth wireless network adaptor. Each of the WAN adaptor 152, LAN adaptor 153, and/or PAN adaptor 154 may be coupled to an antenna, including multiple antennas configured for primary and diversity reception and/or configured for receiving specific frequency bands. In some embodiments, antennas may be shared for communicating on different networks by the WAN adaptor 152, LAN adaptor 153, and/or PAN adaptor 154. In some embodiments, the WAN adaptor 152, LAN adaptor 153, and/or PAN adaptor 154 may share circuitry and/or be packaged together, such as when the LAN adaptor 153 and the PAN adaptor 154 are packaged as a single integrated circuit (IC).

The device 100 may further include or be coupled to a power supply 118 for the device 100, such as a battery or an adaptor to couple the device 100 to an energy source. The device 100 may also include or be coupled to additional features or components that are not shown in FIG. 1. In one example, a wireless interface, which may include a number of transceivers and a baseband processor in a radio frequency front end (RFFE), may be coupled to or included in WAN adaptor 152 for a wireless communication device. In a further example, an analog front end (AFE) to convert analog image data to digital image data may be coupled between the first image sensor 101 or second image sensor 102 and processing circuitry in the device 100. In some embodiments, AFEs may be embedded in the ISP 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, which is a device configured for measuring rotation, orientation, and/or angular velocity to generate motion data. Another example non-camera sensor is an accelerometer, which is a device configured for measuring acceleration, which may also be used to determine velocity and distance traveled by appropriately integrating the measured acceleration. In some aspects, a gyroscope in an electronic image stabilization system (EIS) may be coupled to the sensor hub. In another example, a non-camera sensor may be a global positioning system (GPS) receiver, which is a device for processing satellite signals, such as through triangulation and other techniques, to determine a location of the device 100. The location may be tracked over time to determine additional motion information, such as velocity and acceleration. The data from one or more sensors may be accumulated as motion data by the sensor hub 150. One or more of the acceleration, velocity, and/or distance may be included in motion data provided by the sensor hub 150 to other components of the device 100, including the ISP 112 and/or the processor 104.

The ISP 112 may receive captured image data. In one embodiment, a local bus connection couples the ISP 112 to the first image sensor 101 and second image sensor 102 of a first camera 103 and second camera 105, respectively. In another embodiment, a wire interface couples the ISP 112 to an external image sensor. In a further embodiment, a wireless interface couples the ISP 112 to the first image sensor 101 or second image sensor 102.

The first image sensor 101 and the second image sensor 102 are configured to capture image data representing a scene in the field of view of the first camera 103 and second camera 105, respectively. In some embodiments, the first camera 103 and/or second camera 105 output analog data, which is converted by an analog front end (AFE) and/or an analog-to-digital converter (ADC) in the device 100 or embedded in the ISP 112. In some embodiments, the first camera 103 and/or second camera 105 output digital data. The digital image data may be formatted as one or more image frames, whether received from the first camera 103 and/or second camera 105 or converted from analog data received from the first camera 103 and/or second camera 105.

The first camera 103 may include the first image sensor 101 and a first lens 131. The second camera may include the second image sensor 102 and a second lens 132. Each of the first lens 131 and the second lens 132 may be controlled by an associated autofocus (AF) algorithm (e.g., AF 133) executing in the ISP 112, which adjusts the first lens 131 and the second lens 132 to focus on a particular focal plane located at a certain scene depth. The AF 133 may be assisted by depth data received from depth sensor 140. The first lens 131 and the second lens 132 focus light at the first image sensor 101 and second image sensor 102, respectively, through one or more apertures for receiving light, one or more shutters for blocking light when outside an exposure window, and/or one or more color filter arrays (CFAs) for filtering light outside of specific frequency ranges. The first lens 131 and second lens 132 may have different fields of view (FOVs) to capture different representations of a scene. For example, the first lens 131 may be an ultra-wide (UW) lens and the second lens 132 may be a wide (W) lens. The multiple image sensors may include a combination of UW, W, tele (T), and ultra-tele (UT) sensors.

Each of the first camera 103 and second camera 105 may be configured through hardware configuration and/or software settings to obtain different, but overlapping, FOVs. In some configurations, the cameras are configured with different lenses with different magnification ratios that result in different fields of view for capturing different representations of the scene. The cameras may be configured such that a UW camera has a larger FOV than a W camera, which has a larger FOV than a T camera, which has a larger FOV than a UT camera. For example, a camera configured for wide FOV may capture fields of view in the range of 64-84 degrees, a camera configured for ultra-side FOV may capture fields of view in the range of 100-140 degrees, a camera configured for tele FOV may capture fields of view in the range of 10-30 degrees, and a camera configured for ultra-tele FOV may capture fields of view in the range of 1-8 degrees.

In some embodiments, one or more of the first camera 103 and/or second camera 105 may be a variable aperture (VA) camera in which the aperture can be adjusted to set a particular aperture size. Example aperture sizes include f/2.0, f/2.8, f/3.2, f/8.0, etc. Larger aperture values correspond to smaller aperture sizes, and smaller aperture values correspond to larger aperture sizes. A VA camera may have different characteristics that produced different representations of a scene based on a current aperture size. For example, a VA camera may capture image data with a depth of focus (DOF) corresponding to a current aperture size set for the VA camera.

The ISP 112 processes image data captured by the first camera 103 and second camera 105. While FIG. 1 illustrates the device 100 as including first camera 103 and second camera 105, any number (e.g., one, two, three, four, five, six, etc.) of cameras may be coupled to the ISP 112. In some aspects, depth sensors such as depth sensor 140 may be coupled to the ISP 112. Output from the depth sensor 140 may be processed in a similar manner to that of first camera 103 and second camera 105. Examples of depth sensor 140 include active sensors, including one or more of indirect Time of Flight (iToF), direct Time of Flight (dToF), light detection and ranging (Lidar), mmWave, radio detection and ranging (Radar), and/or hybrid depth sensors, such as structured light sensors. In embodiments without a depth sensor 140, similar information regarding depth of objects or a depth map may be determined from the disparity between first camera 103 and second camera 105, such as by using a depth-from-disparity algorithm, a depth-from-stereo algorithm, phase detection auto-focus (PDAF) sensors, or the like. In addition, any number of additional image sensors or image signal processors may exist for the device 100.

In some embodiments, the ISP 112 may execute instructions from a memory, such as instructions 108 from the memory 106, instructions stored in a separate memory coupled to or included in the ISP 112, or instructions provided by the processor 104. In addition, or in the alternative, the ISP 112 may include hardware (such as one or more integrated circuits (ICs)) configured to perform one or more operations described in the present disclosure. To illustrate, the ISP 112 may include a dynamic imbalance reduction engine 110 that may initiate, perform, or control one or more operations described herein. Depending on the implementation, the dynamic imbalance reduction engine 110 may be implemented using instructions executable by the ISP 112, hardware, or a combination thereof.

FIG. 1 also illustrates that the ISP 112 may include image front ends (e.g., IFE 135), image post-processing engines (e.g., IPE 136), auto exposure compensation (AEC) engines (e.g., AEC 134), and/or one or more engines for video analytics (e.g., EVA 137). An image pipeline may be formed by a sequence of one or more of the IFE 135, IPE 136, and/or EVA 137. In some embodiments, the image pipeline may be reconfigurable in the ISP 112 by changing connections between the IFE 135, IPE 136, and/or EVA 137. The AF 133, AEC 134, IFE 135, IPE 136, and EVA 137 may each include application-specific circuitry, be embodied as software or firmware executed by the ISP 112, and/or a combination of hardware and software or firmware executing on the ISP 112.

The memory 106 may include a non-transient or non-transitory computer readable medium storing computer-executable instructions as instructions 108 to perform all or a portion of one or more operations described herein. The instructions 108 may include a camera application (or other suitable application such as a messaging application) to be executed by the device 100 for photography or videography. The instructions 108 may also include other applications or programs executed by the device 100, such as an operating system and applications other than for image or video generation. Execution of the camera application, such as by the processor 104, may cause the device 100 to record images using the first camera 103 and/or second camera 105 and the ISP 112.

In addition to instructions 108, the memory 106 may also store image frames. The image frames may be output image frames stored by the ISP 112. The output image frames may be accessed by the processor 104 for further operations. In some embodiments, the device 100 does not include the memory 106. For example, the device 100 may be a circuit including the ISP 112, and the memory may be outside the device 100. The device 100 may be coupled to an external memory and configured to access the memory for writing output image frames for display or long-term storage. In some embodiments, the device 100 is a system-on-chip (SoC) that incorporates the ISP 112, the processor 104, the sensor hub 150, the memory 106, and/or components 116 into a single package.

In some embodiments, the processor 104 may include one or more processor cores 104A-N capable of executing instructions to control operation of the ISP 112. For example, the cores 104A-N may execute a camera application (or another application for generating images or video) stored in the memory 106 to activate or deactivate the ISP 112 for capturing image frames and/or to one or more operations associated with the dynamic imbalance reduction engine 110.

In some embodiments, the processor 104 may include ICs or other hardware (e.g., an artificial intelligence (AI) engine such as AI engine 124 or other co-processor) to offload certain tasks from the cores 104A-N. The AI engine 124 may be used to offload tasks related to, for example, face detection and/or object recognition performed using machine learning (ML) or artificial intelligence (AI). The AI engine 124 may be referred to as an Artificial Intelligence Processing Unit (AIPU). The AI engine 124 may include hardware configured to perform and accelerate convolution operations involved in executing machine learning algorithms, such as by executing predictive models such as artificial neural networks (ANNs) (including multilayer feedforward neural networks (MLFFNN), the recurrent neural networks (RNN), and/or the radial basis functions (RBF)). The ANN executed by the AI engine 124 may access predefined training weights for performing operations on user data. The ANN may alternatively be trained during operation of the image capture device 100, such as through reinforcement training, supervised training, and/or unsupervised training. In some other embodiments, the device 100 may not include the processor 104, such as when all of the described functionality is configured in the ISP 112.

In some embodiments, the display 114 may include one or more displays or screens allowing for user interaction and/or to present items to the user, such as a preview of the output of the first camera 103 and/or second camera 105. In some embodiments, the display 114 is a touch-sensitive display. The input/output (I/O) components, such as components 116, may be or include any suitable mechanism, interface, or device to receive input (such as commands) from the user and to provide output to the user through the display 114. For example, the components 116 may include (but are not limited to) a graphical user interface (GUI), a keyboard, a mouse, a microphone, speakers, a squeezable bezel, one or more buttons (such as a power button), a slider, a toggle, or a switch.

During operation, the ISP 112 may receive image data 107 from one or more of the first camera 103 or the second camera 105. The ISP 112 may perform imbalance reduction associated with the image data 107 using the dynamic imbalance reduction engine 110 to generate output image data 148. In some implementations, the ISP 112 may provide the output image data 148 to the processor 104. In some other implementations, the ISP 112 may perform one or more other operations using the output image data 148, such as by storing the output image data 148 to the memory 106, sending the output image data 148 to another device (e.g., via the components 116), or performing one or more other operations.

In some implementations, at least one of the ISP 112 or the processor 104 executes instructions to perform one or more operations described herein, such as imbalance reduction. For example, execution of the instructions may cause the ISP 112 to begin or end capturing an image frame or a sequence of image frames using one or more cameras, such as the first camera 103, the second camera 105, or both. The image data 107 may include the image frame or sequence of image frames. Further, execution of the instructions may cause the ISP 112 to perform imbalance correction of the image frame or sequence of image frames using the dynamic imbalance reduction engine 110 to generate the output image data 148. In addition, execution of the instructions may cause the ISP 112 to perform one or more operations based on the output image data 148. In some examples, the one or more operations may include storing the output image data 148 to the memory 106, presenting the output image data 148 via the display 114, transmitting the output image data 148 to another device via the components 116, providing the output image data 148 to the processor 104, performing one or more other operations, or a combination thereof.

While shown to be coupled to each other via the processor 104, components (such as the processor 104, the memory 106, the ISP 112, the display 114, and the components 116) may be coupled to each another in other various arrangements, such as via one or more local buses, which are not shown for simplicity. One example of a bus for interconnecting the components is a peripheral component interface (PCI) express (PCIe) bus.

While the ISP 112 is illustrated as separate from the processor 104, the ISP 112 may be a core of a processor 104 that is an application processor unit (APU), included in a system on chip (SoC), or otherwise included with the processor 104. Additionally, other components, numbers of components, or combinations of components may be included in a device for performing aspects of the present disclosure. As such, the present disclosure is not limited to a specific device or configuration of components, including the device 100.

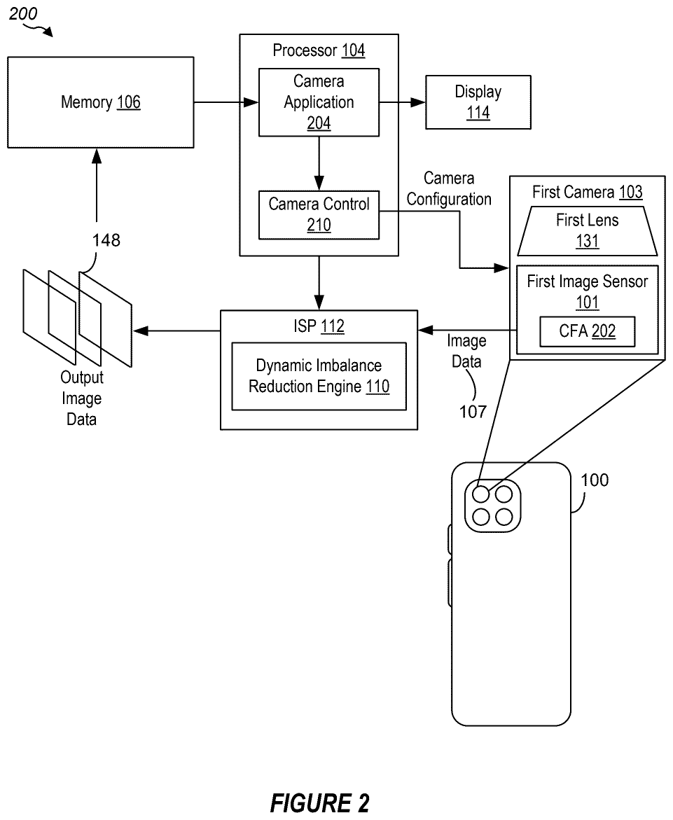

FIG. 2 is a block diagram illustrating an example data flow path for image data processing in an image capture device. Although FIG. 2 may depict an implementation of the device 100 as a mobile device (such as a smart phone) for illustration, in some other examples, one or more features of the disclosure may be used with another type of device. To illustrate, in some other examples, the device 100 may be implemented as or included in a wearable device, such as a smart watch or a headset, in a standalone camera (such as a video surveillance camera), in a vehicle, or in another device, as illustrative examples.

Processor 104 of system 200 may communicate with ISP 112 through a bi-directional bus and/or separate control and data lines. The processor 104 may control the first camera 103 through camera control 210. The camera control 210 may be a camera driver executed by the processor 104 for configuring the first camera 103, such as to active or deactivate image capture, configure exposure settings, and/or configure aperture size. Camera control 210 may be managed by a camera application 204 executing on the processor 104. The camera application 204 provides settings accessible to a user such that a user can specify individual camera settings or select a profile with corresponding camera settings. Camera control 210 communicates with the first camera 103 to configure the first camera 103 in accordance with commands received from the camera application 204. The camera application 204 may be, for example, a photography application, a document scanning application, a messaging application, or other application that processes image data.

The camera configuration may include parameters that specify, for example, a frame rate, an image resolution, a readout duration, an exposure level, an aspect ratio, an aperture size, etc. The first camera 103 may apply the camera configuration and obtain image data 107 representing a scene using the camera configuration. In some embodiments, the camera configuration may be adjusted to obtain different representations of the scene. For example, the processor 104 may execute a camera application 204 to instruct the first camera 103, through camera control 210, to set a first camera configuration for the first camera 103, to obtain first image data from the first camera 103 operating in the first camera configuration, to instruct the first camera 103 to set a second camera configuration for the first camera 103, and to obtain second image data from the first camera 103 operating in the second camera configuration. The first image data and the second image data may be included in the image data 107.

In some implementations in which the first camera 103 may be a variable aperture (VA) camera system, the processor 104 may execute a camera application 204 to instruct the first camera 103 to configure to a first aperture size, obtain the first image data from the first camera 103, instruct the first camera 103 to configure to a second aperture size, and obtain the second image data from the first camera 103. The reconfiguration of the aperture and obtaining of the first and second image data may occur with little or no change in the scene captured at the first aperture size and the second aperture size. Example aperture sizes are f/2.0, f/2.8, f/3.2, f/8.0, etc. Larger aperture values correspond to smaller aperture sizes, and smaller aperture values correspond to larger aperture sizes. That is, f/2.0 corresponds to a larger aperture size than f/8.0.

The image data 107 may be processed in one or more blocks of the ISP 112 to determine output image data 148 that may be stored in memory 106 and/or otherwise provided to the processor 104. The processor 104 may further process the image data 107 to apply effects to the output image data 148. Effects may include Bokeh, lighting, color casting, and/or high dynamic range (HDR) merging. In some embodiments, the effects may be applied in the ISP 112. The output image data 148 may be presented to a user, such as via the display 114 of FIG. 1.

A camera described herein may include or may operate in accordance with a color filter array (CFA). For example, the first camera 103 may include or may operate in accordance with a CFA 202. Further, generating the image data 107 may include generating color data using the CFA 202. The color data may indicate intensities of different colors associated with the CFA 202. Each such color may be associated with or may be referred to as a channel of the CFA 202. To illustrate, the CFA 202 may be associated with green channels, blue channels, and red channels. The color data may indicate intensities of light received via the green channels, the blue channels, and the red channels. The color data may be included in or associated with the image data 107.

To further illustrate, in some examples, the CFA 202 may correspond to a Bayer CFA, a quad-CFA (QCFA), a 4×4 CFA, a QCFA with quad phase detection (QPD) CFA, a 4×4 CFA with QPD, or any other potential CFAs, as illustrative examples. The CFA 202 may also be referred to as a color filter mosaic (CFM).

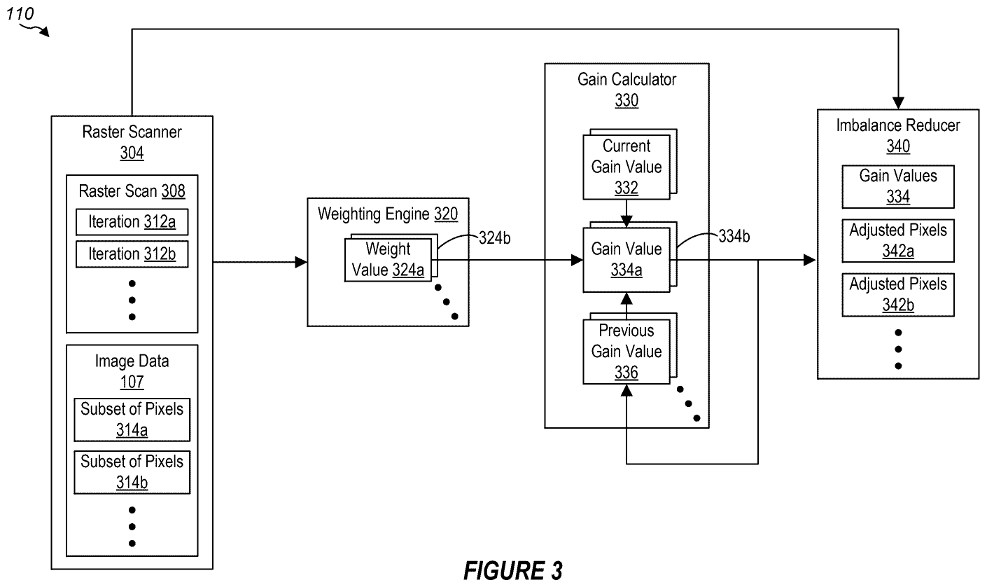

FIG. 3 is a block diagram illustrating an example of the dynamic imbalance reduction engine 110. In the example illustrated in FIG. 3, the dynamic imbalance reduction engine 110 may include a raster scanner 304, a weighting engine 320, a gain calculator 330, and an imbalance reducer 340. An output of the raster scanner 304 may be coupled to an input of the weighting engine 320 and to an input of the imbalance reducer 340. An output of the weighting engine 320 may be coupled to an input of the gain calculator 330. An output of the gain calculator 330 may be coupled to an input of the imbalance reduce 340. Further, the output of the gain calculator 330 may be coupled to an input (e.g., a feedback input) of the gain calculator 330, such as via a feedback path.

During operation, the raster scanner 304 may receive the image data 107. The raster scanner 304 may perform a raster scan 308 of the image data 107. The raster scan 308 may include multiple iterations, where the raster scanner 304 selects, for each iteration, a respective subset of pixels of the image data 107. To illustrate, the raster scan 308 may include a first iteration 312a that includes selecting a first subset of pixels 314a of the image data 107 and may also include a second iteration 312b that includes selecting a first subset of pixels 314a of the image data 107.

In some examples, each subset of pixels 314 of the image data 107 may include a particular quantity of pixels, such as four pixels, as a non-limiting example. To further illustrate, each pixel of a subset of pixels 314 may be associated with a respective channel of the CFA 202 of FIG. 2. In some examples, the CFA 202 may include four blue channels, and each subset of pixels 314 may include a respective pixel for each of the four blue channels. Other examples are also within the scope of the disclosure.

The raster scanner 304 may provide each such subset of pixels of the image data 107 to the weighting engine 320. To illustrate, the raster scanner 304 may provide the first subset of pixels 314a to the weighting engine 320 in connection with (e.g., during, or based on) the first iteration 312a. The raster scanner 304 may provide the second subset of pixels 314b to the weighting engine 320 in connection with (e.g., during, or based on) the second iteration 312b.

The weighting engine 320 may determine weight values including a weight value for each subset of pixels of the image data provided to the weighting engine 320 by the raster scanner 304. Each such weight value may indicate a probability that the subset of pixels corresponds to a relatively homogeneous (or “flat”) region of the image data 107. A relatively homogeneous (or flat) region of the image data 107 may include pixel values of equal (or approximately equal) intensities for different channels of the CFA 202 of FIG. 2. In some examples, the weighting engine 320 may identify the relatively homogeneous region based on determining that the region includes pixel intensities for different channels of the CFA 202 that are within a threshold difference of one another. The weighting engine 320 may determine that one or more other regions of the image data 107 correspond to non-homogenous regions based on determining that the one or more other regions include pixel intensities for different channels of the CFA 202 that exceed a threshold difference of one another.

To illustrate, in connection with the first iteration 312a, the weighting engine 320 may determine a first weight value 324a indicating a probability that the first subset of pixels 314a corresponds to a homogeneous region of the image data 107. In connection with the second iteration 312b, the weighting engine 320 may determine a second weight value 324b indicating a probability that the second subset of pixels 314b corresponds to a homogeneous region of the image data 107.

To further illustrate, in some implementations, each weight value generated by the weighting engine 320 may have a value selected from the set (0, 1). For example, if the weighting engine 320 determines that the first subset of pixels 314 is not a homogeneous region, the first weight value 324a may correspond to zero. As another example, if the weighting engine 320 determines that the first subset of pixels 314 is a homogeneous region, the first weight value 324a may correspond to one. As an additional example, if the weighting engine 320 determines that the first subset of pixels 314 may correspond to a homogeneous region with a probability of 50 percent, the first weight value 324a may correspond to 0.5. Each weight value may also be referred to as a flat flag.

The gain calculator 330 may determine gain values 334 in connection with the raster scan 308. In some examples, the gain values 334 may include a gain value for each iteration of the raster scan 308. Further, each such gain value of the gain values 334 may correspond to a different subset of pixels of the image data 107. For example, the gain calculator 330 may determine a first gain value 334a of the gain values 334 in connection with the first iteration 312a of the raster scan 308. The first gain value 334a may be associated with the first subset of pixels 314a. As another example, the gain calculator 330 may determine a second gain value 334b of the gain values 334 in connection with the second iteration 312b of the raster scan 308. The second gain value 334b may be associated with the second subset of pixels 314b.

In some examples, each gain value 334 may include multiple gain values for each blue channel associated with the CFA 202 of FIG. 2. For example, the CFA 202 may include four blue channels, and each gain value 334 may correspond to a vector that includes a respective gain value for each of the four blue channels. Other examples are also within the scope of the disclosure.

In some implementations, each gain value of the gain values 334 may be based on a respective weight value of the weight values determined by the weighting engine 320. For example, the gain calculator 330 may determine the first gain value 334a based on the first weight value 324a and may determine the second gain value 334b based on the second weight value 324b. As a result, a gain value 334 for a relatively homogenous region of the image data 107 may be weighted more heavily than another gain value 334 associated with a non-homogenous region of the image data 107.

Further, in some implementations, at least some gain values 334 output by the gain calculator 330 may be fed back to the gain calculator 330 (e.g., via a feedback path) for use in determining at least some other gain values 334. To illustrate, in connection with the first iteration 312a, the gain calculator 330 may determine the first gain value 334a and may subsequently determine, in connection with the second iteration 312b, the second gain value 334b based on the first gain value 334a (e.g., by scaling the second gain value 334b based on the first gain value 334a). In this example, the first gain value 334a may be referred to as a previous gain value 336 in connection with the second iteration 312b. Further, prior to scaling the second gain value 334b based on the previous gain value 336, the second gain value 334b may be referred to as a current gain value 332. Accordingly, the gain values 334 may be determined in accordance with a moving weighted average.

The imbalance reducer 340 may receive the gain values 334 from the gain calculator 330 and may also receive the image data 107 (e.g., from the raster scanner 304). The imbalance reducer 340 may apply the gain values 334 to the image data 107 to generate output image data, such as the output image data 148 of FIGS. 1 and 2. To illustrate, the imbalance reducer 340 may apply the first gain value 334a to the first subset of pixels 314a to generate adjusted pixels 342a. The imbalance reducer 340 may apply the second gain value 334b to the second subset of pixels 314b to generate adjusted pixels 342b. In some examples, the output image data 148 of FIGS. 1 and 2 may include the adjusted pixels 342a and 342b. In some examples, generating the output image data 148 of FIGS. 1 and 2 may include applying the gain values 334 to the image data 107 to reduce or correct a green imbalance associated with the image data 107.

In some examples, the dynamic imbalance reduction engine 110 may determine the gain values 334 on-the-fly (OTF) in connection with capturing the image data 107 and during image processing of the image data 107. For example, the dynamic imbalance reduction engine 110 may determine the gain values 334 after capture of the image data 107 but prior to outputting the output image data 148. In some examples, determining the gain values 334 in such a manner may be referred to as just-in-time determination of the gain values 334.

To further illustrate, Example 1 shows illustrative pseudocode that may be associated with operation of the dynamic imbalance reduction engine 110:

### Example 1

Determine current_gain for location (x, y):
Ch0_gain=P_avg/P0;
Ch1_gain=P_avg/P1;
Ch2_gain=P_avg/P2;
Ch3_gain=P_avg/P3;
where P_avg=(P0+P1+P2+P3)/4;

Determine weight_value for location (x, y):
If region is flat, then weight_value=1;
If region is not flat, then weight_value=0;
If in between, then 0<weight_value<1;

Determine previous_gain:
If (x, y)=(0,0), then set initial condition as previous_gain=1;
Else retrieve previous_gain calculated for prior iteration;

Determine final_gain for location (x, y):
Final_gain=weight_value*current_gain+(1-weight_value)*previous_gain

Apply final_gain to location (x, y):
Output(x, y)=input(x, y)*final_gain

In Example 1, x and y may correspond to coordinates of a pixel of the image data 107, the location (x, y) may correspond to a subset of pixels of the image data 107, such as the first subset of pixels 314a or the second subset of pixels 314b. In some examples, the subset may include pixel (x, y) and may further include three neighbor pixels of pixel (x, y), such as pixels (x+1, y), (x, y+1), and (x+1, y+1). The subset of pixels indicated as location (x, y) may be referred to as pixels P0, P1, P2, and P3.

Further, current_gain may correspond to the current gain value 332 for location (x, y). As illustrated in Example 1, current_gain may include multiple current gain values respectively associated with pixels P0, P1, P2, and P3. The multiple current gain values may include Ch0_gain associated with pixel P0, Ch1_gain associated with pixel P1, Ch2_gain associated with pixel P2, and Ch3_gain associated with pixel P3. Further, each such current gain value may be determined based on P_avg, which may indicate an average of pixels P0, P1, P2, and P3.

In addition, weight_value may correspond to the weight value 324 associated with the location (x, y).

In Example 1, previous_gain may indicate the previous gain value 336 associated with a prior iteration of the raster scan 308. In some examples, each gain value of the gain values 334 may be based on a previous gain value 336 (e.g., previous_gain in Example 1) from a prior iteration of the raster scan 308, and, for an initial iteration of the raster scan 308, the previous gain value 336 may be initialized to a default value. In Example 1, the default value may correspond to one (e.g., previous_gain=1).

Example 1 also illustrates that a particular gain value 334 (e.g., final_gain) for location (x, y) may be determined based on weight_value, previous_gain, and current_gain. After determining final_gain, pixels of location (x, y) may be scaled based final_gain to generate output pixels. In one example, the location (x, y) may correspond to the first subset of pixels 314a, and the output pixels may correspond to the adjusted pixels 342a. In another example, the location (x, y) may correspond to the second subset of pixels 314b, and the output pixels may correspond to the adjusted pixels 342b. The output pixels may be included in the output image data 148 of FIGS. 1 and 2.

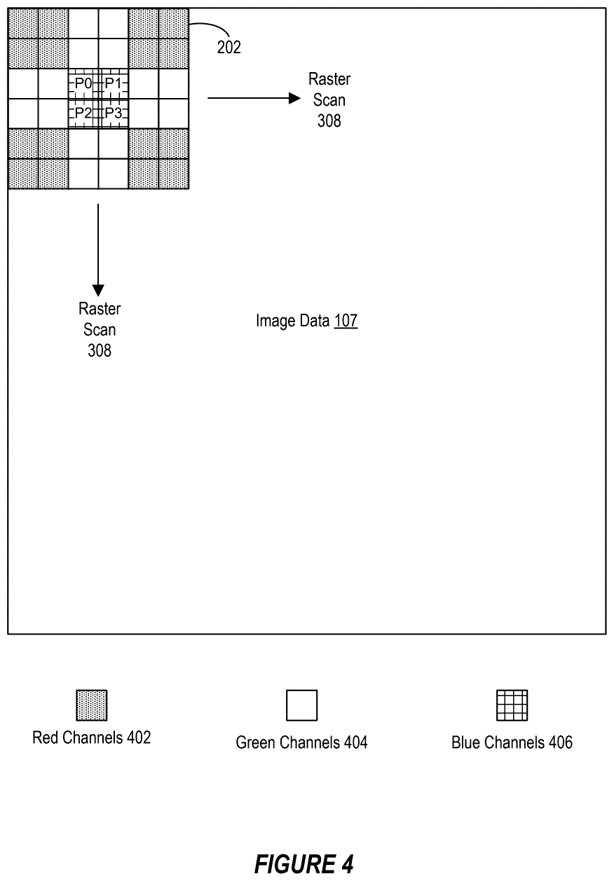

FIG. 4 is a block diagram illustrating an example of performing the raster scan 308 using the CFA 202. In the example of FIG. 4, the CFA 202 may include red channels 402, green channels 404, and blue channels 406. FIG. 4 illustrates that the blue channels 406 may form a center portion of the CFA 202, and the green channels 404 and the red channels 402 may form a peripheral portion of the CFA 202. Other examples are also within the scope of the disclosure. For example, in some implementations, the CFA 202 may include a different quantity of colors, a different arrangement of colors, or both. In an example, the CFA 202 may include red channels, green channels, blue channels, and white channels. In this example, the CFA 202 may be referred to as having a red, green, blue, and white (RGBW) pattern. Other examples are also within the scope of the disclosure.

In some examples, the CFA 202 may include a first quantity of the blue channels 406, a second quantity of the green channels 404, and a third quantity of the red channels 402. The third quantity may correspond to the second quantity, and the first quantity may be less than the second quantity and the third quantity. Because the CFA 202 may include more green channels 404 as blue channels 406 (e.g., twice as many green channels 404 as blue channels 406), the image data 107 may be associated with a channel imbalance (also referred to as a green imbalance). To illustrate, in some implementations, the CFA 202 may include sixteen red channels 402, sixteen green channels 404, and four blue channels 406. In some such examples, a 6×6 kernel may be used. Other examples are also within the scope of the disclosure. For example, other implementations may use a different configuration of channels and may use a different kernel.

During operation, the raster scan 308 may be performed based on the CFA 202. For example, for each position of the CFA 202 during the raster scan, each channel of the CFA 202 may determine color data associated with a corresponding pixel of the image data 107. Performing the raster scan 308 may include moving the CFA 202 about the image data 107 to select multiple subsets of pixels of the image data 107. The multiple subsets may include first subset of pixels 314a and the second subset of pixels 314b of FIG. 3. Each subset of the multiple subsets may include pixels associated with a first region of the CFA 202 (e.g., the blue region of the CFA 202, which may correspond to the center of the CFA 202) and may exclude pixels associated with a second region of the CFA 202 and a third region of the CFA 202 (e.g., the red and green regions of the CFA 202, which may correspond to the periphery of the CFA 202). The pixels associated with the blue region may include pixels P0, P1, P2, and P3.

To further illustrate, the first subset of pixels 314a may include, for a first region of the image data 107, first pixels associated with the blue channels 406 and may exclude, for the first region, second pixels associated with the green channels 404 and the red channels 402. The second subset of pixels 314b may include, for a second region of the image data 107 different than the first region, third pixels associated with the blue channels 406 and may exclude, for the second region, fourth pixels associated with the green channels 404 and the red channels 402. For each such region, the pixels associated with the blue channels 406 (e.g., the first pixels and the third pixels) may be referred to as pixels P0, P1, P2, and P3.

In some examples, the imbalance reducer 340 of FIG. 3 may perform channel imbalance reduction by selectively determining and applying the gain values 334 (e.g., on a per-color basis). For example, the imbalance reducer 340 may perform channel imbalance reduction by applying a first plurality of gain values (e.g., the gain values 334) to first pixels associated with a first color of the CFA 202 (e.g., blue) independently of second pixels associated with a second color of the CFA 202 (e.g., red) and independently of third pixels associated with a third color of the CFA 202 (e.g., green). Further, although some examples may be described with reference to blue channels of the CFA 202 for illustration, it should be appreciated that such examples may be performed for other channels of the CFA 202, such as for red channels and green channels. To illustrate, the imbalance reducer 340 may determine and apply a second plurality of gain values to the second pixels (e.g., independently of, and without applying such gain values to, the first pixels and the second pixels). The imbalance reducer 340 may also determine and apply a third plurality of gain values to the third pixels (e.g., independently of, and without applying such gain values to, the first pixels and the second pixels). Accordingly, the imbalance reducer 340 may determine and may apply gain values on a per-color basis.

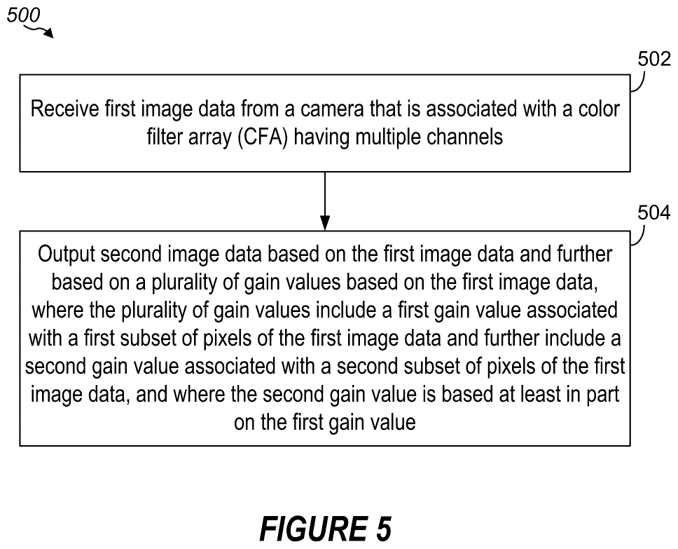

FIG. 5 is a flow chart illustrating an example method 500 for image processing. In some examples, the method 500 may be performed by the device 100. For example, at least some operations of the method 500 may be performed by the ISP 112.

The method 500 may include receiving first image data from a camera that is associated with a color filter array (CFA) having multiple channels, at 502. For example, the ISP 112 may receive image data 107 from the first camera 103, the second camera 105, or both. The image data 107 may be associated with (e.g., may be generated using) the CFA 202. The CFA 202 may have multiple channels, such as red channels 402, the green channels 404, and the blue channels 406. Other examples are also within the scope of the disclosure. For example, in some implementations, the CFA 202 may include white channels, such as in connection with a red, green, blue, and white (RGBW) pattern.

The method 500 may further include outputting second image data based on the first image data and further based on a plurality of gain values based on the first image data, at 504. The plurality of gain values include a first gain value associated with a first subset of pixels of the first image data and further include a second gain value associated with a second subset of pixels of the first image data. The second gain value is based at least in part on the first gain value. To illustrate, the ISP 112 (or another device) may output the output image data 148 based on the image data 107 and further based on the gain values 334. The plurality of gain values may correspond to the gain values 334. The first gain value 334a may be associated with the first subset of pixels 314a, and the second gain value 334b may be associated with the second subset of pixels 314b. The second gain value 334b may be based at least in part on the first gain value 334a.

By dynamically determining the gain values 334 to reduce or correct a channel imbalance, performance may be improved and cost and complexity may be reduced as compared to other techniques. For example, the device 100 may avoid the storage and retrieval of a large calibration data table, which may use a relatively valuable non-volatile memory for storage, such as one-time programmable (OTP) memory. As a result, availability of processing resources and memory resources may be increased.

As another example, individual calibration of devices to reduce channel imbalance during manufacturing may be avoided. Individually operating each device to calibrate for channel imbalance consumes time and equipment and incurs cost. Accordingly, dynamic determination of the gain values 334 may reduce cost, complexity, and duration of a manufacturing process.

In addition, dynamic determination of the gain values 334 may be more resilient to certain variations (e.g., manufacturing variations or variations that occur during device operation) as compared to some calibration processes. For example, variations may occur during device operation, such as due to changes in color temperature, lens position, or optical image stabilization (OIS) position. A calibration technique that uses a static calibration data table may be unable to account for such variations.

Further, dynamic determination of the gain values 334 may scale more favorably for some types of designs. Such designs may include higher resolution image sensors, OIS techniques that use a large range of OIS positions, and other designs. In some cases, a calibration process may be infeasible to implement with such designs (e.g., where a calibration process cannot be performed for a large range of OIS positions).

Additionally, dynamic determination of the gain values 334 may improve performance as compared to a calibration process in some cases. For example, some calibration processes may attempt to reduce the size of a calibration data table by applying a “one size fits all” calibration profile for different operating conditions. Such a technique may result in poor image quality (e.g., where a channel mismatch is conspicuous in an output image for at least some of the operating conditions). Other calibration processes may attempt to use interpolation to create multiple different calibration profiles for different operating conditions. Such a technique may decrease performance by, for example, increasing latency and by consuming processing resources and memory resources.

In a first aspect, an apparatus includes a processing system comprising one or more memories and one or more processors coupled to the one or more memories. The processing system is configured to receive first image data from a camera that is associated with a color filter array (CFA) having multiple channels and to output second image data based on the first image data and further based on a plurality of gain values based on the first image data. The plurality of gain values include a first gain value associated with a first subset of pixels of the first image data and further include a second gain value associated with a second subset of pixels of the first image data. The second gain value is based at least in part on the first gain value.

In a second aspect, in combination with the first aspect, the processing system is further configured to perform channel imbalance reduction by applying the plurality of gain values to first pixels associated with a first color of the CFA independently of second pixels associated with a second color of the CFA and independently of third pixels associated with a third color of the CFA.

In a third aspect, in combination with one or more of the first aspect or the second aspect, in connection with the channel imbalance reduction, the processing system is further configured to apply a second plurality of gain values to the second pixels independently of the first pixels and independently of the third pixels and to apply a third plurality of gain values to the third pixels independently of the first pixels and independently of the second pixels.

In a fourth aspect, in combination with one or more of the first aspect through the third aspect, the processing system is further configured to perform a raster scan of the first image data based on the CFA, to determine the first gain value in connection with a first iteration of the raster scan, and to determine the second gain value in connection with a second iteration of the raster scan subsequent to the first iteration.

In a fifth aspect, in combination with one or more of the first aspect through the fourth aspect, each gain value of the plurality of gain values is based on a previous gain value from a prior iteration of the raster scan, and, for an initial iteration of the raster scan, the processing system is further configured to initialize the previous gain value to a default value.

In a sixth aspect, in combination with one or more of the first aspect through the fifth aspect, in connection with the raster scan, the processing system is further configured to move the CFA about the first image data to select a plurality of subsets of pixels of the first image data including the first subset and the second subset. Each subset of the plurality of subsets includes pixels associated with a first region of the CFA and excludes pixels associated with a second region of the CFA and a third region of the CFA.

In a seventh aspect, in combination with one or more of the first aspect through the sixth aspect, the processing system is further configured to generate the second image data by applying the plurality of gain values to the first image data to reduce or correct a green imbalance associated with the first image data.

In an eighth aspect, in combination with one or more of the first aspect through the seventh aspect, the processing system is further configured to determine a plurality of weight values, and the plurality of weight values includes, for each subset of pixels of the first image data provided by a raster scanner, a weight value indicating a probability that the subset of pixels corresponds to a homogeneous region of the first image data.

In a ninth aspect, in combination with one or more of the first aspect through the eighth aspect, each gain value of the plurality of gain values is based on a respective weight value of the plurality of weight values.

In a tenth aspect, in combination with one or more of the first aspect through the ninth aspect, the processing system is further configured to determine the plurality of gain values on-the-fly (OTF) in connection with capturing the first image data and during image processing of the first image data.

In an eleventh aspect, a method includes receiving first image data from a camera that is associated with a color filter array (CFA) having multiple channels and outputting second image data based on the first image data and further based on a plurality of gain values based on the first image data. The plurality of gain values include a first gain value associated with a first subset of pixels of the first image data and further include a second gain value associated with a second subset of pixels of the first image data, and the second gain value is based at least in part on the first gain value.

In a twelfth aspect, in combination with the eleventh aspect, the method further includes performing channel imbalance reduction by applying the plurality of gain values to first pixels associated with a first color of the CFA independently of second pixels associated with a second color of the CFA and independently of third pixels associated with a third color of the CFA.

In a thirteenth aspect, in combination with one or more of the eleventh aspect through the twelfth aspect, the channel imbalance reduction further includes applying a second plurality of gain values to the second pixels independently of the first pixels and independently of the third pixels and applying a third plurality of gain values to the third pixels independently of the first pixels and independently of the second pixels.

In a fourteenth aspect, in combination with one or more of the eleventh aspect through the thirteenth aspect, the method further includes performing a raster scan of the first image data based on the CFA. The first gain value is determined in connection with a first iteration of the raster scan, and the second gain value is determined in connection with a second iteration of the raster scan subsequent to the first iteration.

In a fifteenth aspect, in combination with one or more of the eleventh aspect through the fourteenth aspect, each gain value of the plurality of gain values is based on a previous gain value from a prior iteration of the raster scan, and, for an initial iteration of the raster scan, the previous gain value is initialized to a default value.

In a sixteenth aspect, in combination with one or more of the eleventh aspect through the fifteenth aspect, performing the raster scan includes moving the CFA about the first image data to select a plurality of subsets of pixels of the first image data including the first subset and the second subset, and each subset of the plurality of subsets includes pixels associated with a first region of the CFA and excludes pixels associated with a second region of the CFA and a third region of the CFA.

In a seventeenth aspect, in combination with one or more of the eleventh aspect through the sixteenth aspect, generating the second image data includes applying the plurality of gain values to the first image data to reduce or correct a green imbalance associated with the first image data.

In an eighteenth aspect, a non-transitory computer-readable medium stores instructions executable by one or more processors to initiate, perform, or control operations. The operations include receiving first image data from a camera that is associated with a color filter array (CFA) having multiple channels and outputting second image data based on the first image data and further based on a plurality of gain values based on the first image data. The plurality of gain values include a first gain value associated with a first subset of pixels of the first image data and further include a second gain value associated with a second subset of pixels of the first image data, and the second gain value is based at least in part on the first gain value.

In a nineteenth aspect, in combination with the eighteenth aspect, the operations further include determining a plurality of weight values. The plurality of weight values includes, for each subset of pixels of the first image data provided by a raster scanner, a weight value indicating a probability that the subset of pixels corresponds to a homogeneous region of the first image data, and each gain value of the plurality of gain values is based on a respective weight value of the plurality of weight values.

In a twentieth aspect, in combination with one or more of the eighteenth aspect through the nineteenth aspect, the operations further include determining the plurality of gain values on-the-fly (OTF) in connection with capturing the first image data and during image processing of the first image data.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and processes described herein may be implemented using electronic hardware, firmware, software, or combinations of hardware, firmware, or software, including the structures disclosed in this specification and the structural equivalents thereof. Whether such functionality is implemented in hardware, firmware, or software may depend upon the particular application and design of the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus comprising:
a processing system comprising one or more memories and one or more processors coupled to the one or more memories, the processing system configured to:
receive first image data from a camera that is associated with a color filter array (CFA) having multiple channels; and
output second image data based on the first image data and further based on a plurality of gain values based on the first image data, wherein the plurality of gain values include a first gain value associated with a first subset of pixels of the first image data and further include a second gain value associated with a second subset of pixels of the first image data, and wherein the second gain value is based at least in part on the first gain value.

2. The apparatus of claim 1, wherein the processing system is further configured to perform channel imbalance reduction by applying the plurality of gain values to first pixels associated with a first color of the CFA independently of second pixels associated with a second color of the CFA and independently of third pixels associated with a third color of the CFA.

3. The apparatus of claim 2, wherein, in connection with the channel imbalance reduction, the processing system is further configured to:
apply a second plurality of gain values to the second pixels independently of the first pixels and independently of the third pixels; and
apply a third plurality of gain values to the third pixels independently of the first pixels and independently of the second pixels.

4. The apparatus of claim 1, wherein the processing system is further configured to:
perform a raster scan of the first image data based on the CFA;
determine the first gain value in connection with a first iteration of the raster scan; and
determine the second gain value in connection with a second iteration of the raster scan subsequent to the first iteration.

5. The apparatus of claim 4, wherein each gain value of the plurality of gain values is based on a previous gain value from a prior iteration of the raster scan, and wherein, for an initial iteration of the raster scan, wherein the processing system is further configured to initialize the previous gain value to a default value.

6. The apparatus of claim 4, wherein, in connection with the raster scan, the processing system is further configured to move the CFA about the first image data to select a plurality of subsets of pixels of the first image data including the first subset and the second subset, and wherein each subset of the plurality of subsets includes pixels associated with a first region of the CFA and excludes pixels associated with a second region of the CFA and a third region of the CFA.

7. The apparatus of claim 6, wherein the processing system is further configured to generate the second image data by applying the plurality of gain values to the first image data to reduce or correct a green imbalance associated with the first image data.

8. The apparatus of claim 1, wherein the processing system is further configured to determine a plurality of weight values, and wherein the plurality of weight values includes, for each subset of pixels of the first image data provided by a raster scanner, a weight value indicating a probability that the subset of pixels corresponds to a homogeneous region of the first image data.

9. The apparatus of claim 8, wherein each gain value of the plurality of gain values is based on a respective weight value of the plurality of weight values.

10. The apparatus of claim 1, wherein the processing system is further configured to determine the plurality of gain values on-the-fly (OTF) in connection with capturing the first image data and during image processing of the first image data.

11. A method comprising:
receiving first image data from a camera that is associated with a color filter array (CFA) having multiple channels; and
outputting second image data based on the first image data and further based on a plurality of gain values based on the first image data, wherein the plurality of gain values include a first gain value associated with a first subset of pixels of the first image data and further include a second gain value associated with a second subset of pixels of the first image data, and wherein the second gain value is based at least in part on the first gain value.

12. The method of claim 11, further comprising performing channel imbalance reduction by applying the plurality of gain values to first pixels associated with a first color of the CFA independently of second pixels associated with a second color of the CFA and independently of third pixels associated with a third color of the CFA.

13. The method of claim 12, wherein the channel imbalance reduction further includes:
applying a second plurality of gain values to the second pixels independently of the first pixels and independently of the third pixels; and
applying a third plurality of gain values to the third pixels independently of the first pixels and independently of the second pixels.

14. The method of claim 11, further comprising performing a raster scan of the first image data based on the CFA, wherein the first gain value is determined in connection with a first iteration of the raster scan, and wherein the second gain value is determined in connection with a second iteration of the raster scan subsequent to the first iteration.

15. The method of claim 14, wherein each gain value of the plurality of gain values is based on a previous gain value from a prior iteration of the raster scan, and wherein, for an initial iteration of the raster scan, the previous gain value is initialized to a default value.

16. The method of claim 14, wherein performing the raster scan includes moving the CFA about the first image data to select a plurality of subsets of pixels of the first image data including the first subset and the second subset, and wherein each subset of the plurality of subsets includes pixels associated with a first region of the CFA and excludes pixels associated with a second region of the CFA and a third region of the CFA.

17. The method of claim 16, wherein generating the second image data includes applying the plurality of gain values to the first image data to reduce or correct a green imbalance associated with the first image data.

18. A non-transitory computer-readable medium storing instructions executable by one or more processors to initiate, perform, or control operations, the operations comprising:
receiving first image data from a camera that is associated with a color filter array (CFA) having multiple channels; and
outputting second image data based on the first image data and further based on a plurality of gain values based on the first image data, wherein the plurality of gain values include a first gain value associated with a first subset of pixels of the first image data and further include a second gain value associated with a second subset of pixels of the first image data, and wherein the second gain value is based at least in part on the first gain value.

19. The non-transitory computer-readable medium of claim 18, wherein the operations further include determining a plurality of weight values, wherein the plurality of weight values includes, for each subset of pixels of the first image data provided by a raster scanner, a weight value indicating a probability that the subset of pixels corresponds to a homogeneous region of the first image data, and wherein each gain value of the plurality of gain values is based on a respective weight value of the plurality of weight values.

20. The non-transitory computer-readable medium of claim 18, wherein the operations further include determining the plurality of gain values on-the-fly (OTF) in connection with capturing the first image data and during image processing of the first image data.
